(19) United States
(12) Patent Application Publication
(10) Pub. No.: US 2009/0015746 A1
(43) Pub. Date: Jan. 15, 2009

(54) LIQUID CRYSTAL DISPLAY PANEL, METHOD FOR MANUFACTURING THE SAME AND APPARTUS INCLUDING THE SAME

(75) Inventors: Chung Te-Chen, Kun Shan (CN); Qiao Yanbing, Kun Shan (CN)

Correspondence Address: CALFEE HALTER & GRISWOLD, LLP, 800 SUPERIOR AVENUE, SUITE 1400, CLEVELAND, OH, 44114, US

(73) Assignee: InfoVision Optoelectronics(Kunshan) Co. Ltd., KunShan City (CN)

(21) Appl. No.: 12/029,087

(22) Filed: Feb. 11, 2008

(30) Foreign Application Priority Data
Jul. 9, 2007 (CN) 200710129580.4

(51) Int. Cl. G02F 1/136; G02F 1/1343

(52) U.S. Cl. 349/42; 349/55

(57) ABSTRACT

The present invention provides a Liquid crystal display (LCD) panel, comprising: a substrate, data lines and gate lines formed on the substrate and intersecting each other, pixel electrodes disposed near the intersecting areas formed by the data lines and the gate lines, wherein, further comprising: a conductive layer having a part overlapped spatially with the pixel electrodes and another part overlapped spatially with the gate lines or the data lines; and a first buffer layer for attenuating the energy of laser beam, which is disposed between the substrate and the pixel electrodes. According to the present invention, when the bright dot defects in the LCD panel are repairing using laser-repairing, a portion of energy from the laser beam can be effectively absorbed, thereby the heating temperature due to the laser beam decreases, so as to prevent the pixel electrodes and conductive layer from being damaged caused by the too high temperature.

### FIELD OF THE INVENTION

The present invention relates to a liquid crystal display (LCD) technology. More particularly, the present invention relates to a LCD panel which is repairable by using laser beam and the method for manufacturing the same, the LCD and portable electronic apparatus including the same and the method for repairing the dot defects in the same.

### BACKGROUND OF THE INVENTION

LCD panel can be classified into two kinds according to its principle, i.e., active matrix one and passive matrix one. The active matrix LCD panel may be made up of millions of the transistors, and the corresponding pixels can be controlled by means of the ON and OFF state of these transistors. However, in the process of manufacturing the active matrix LCD panel, the dot defects often occur due to some manufacturing errors and the like. In general, there are two kinds of dot defect, i.e., bright dot defect and dark dot defect. As a rule, the bright dot defect is very sensitive for human eyes, whereas the dark dot defect has a lower sensitivity. Therefore, the bright dot defects are usually repaired as the dark dot in order to present a satisfactory display effect.

A method for repairing a bright dot defect into a dark dot is discussed in U.S. Pat. No. 5,121,236, which is entitled as “Liquid crystal display element and method for treating defective pixels therein” and was granted on Jun. 9, 1992, the entire content of which is incorporated herein by reference.

Referring to FIGS. 1 and 2, a Thin Film Transistor (TFT) 16 is disposed the underside of a gate line 18, its gate electrode is connected to the gate line 18 and its source electrode is connected to a data line 19; a short-circuited metal layer 28 is formed away from the TFT on the substrate and its two terminals are overlapped spatially with a pixel electrode 15 and the data line 19, respectively; the short-circuited metal layer 28 is isolated from the pixel electrode 15 and the data line 19 by an insulating layer; and metal layers 29 and 31 are disposed above the pixel electrode 15 and the data line 19, respectively, and are opposite to the short-circuited metal layer 28.

When a pixel has a bright dot defect, using the laser-welding technique, the short-circuited metal layer 28 can be welded with the pixel electrode 15 and the data line 19. Specifically, a laser beam irradiating on the transparent substrate punctures the metal layers 29 and 31 and the short-circuited metal layer 28, so that the corresponding portions of the metal layers 29 and 31 and the short-circuited metal layer 28 are melted. At the same time, the corresponding portion of the insulating layer is broken down, thus the pixel electrode 15 can be electrically connected to the data line 19 by means of the metal layer 29 and 31 and the short-circuited metal layer 28, thereby a short circuit may be formed between the pixel electrode 15 and the data line 19.

Since there often is a potential difference between the data line 19 and a common electrode (not shown) when the LCD panel is operating normally □ there also is a potential difference between the corresponding pixel electrode 15 and the common electrode after the formation of the short circuit between the data line 19 and the pixel electrode 15. Thus, the pixel unit having a bright dot defect becomes one having a dark dot defect; thereby it is achieved to repair a pixel unit having a bright dot defect as one having a dark dot defect.

In the above-indicated method, the heating temperature due to the laser beam is usually difficult to be controlled. And the pixel electrodes are very likely to be damaged by the heat generated from the laser beam when the temperature is too high, thereby it is impossible to repair a pixel unit having a bright dot defect as one having a dark dot defect.

### SUMMARY OF THE INVENTION

One object of the present invention is to provide a LCD panel which can effectively prevent pixel electrodes from being damaged in the process of repairing dot defect.

According to the present invention, the liquid crystal display (LCD) panel comprises: a substrate and a plurality of pixel units formed on the substrate, each of the pixel units comprising a data line, a gate line intersecting the data line and a pixel electrode disposed near intersecting area formed by the data line and the gate line, wherein, each of the pixel units further comprising:

a conductive layer having a part overlapped spatially with the pixel electrode and another part overlapped spatially with the gate line or the data line; and,

a first buffer layer for attenuating the energy of laser beam, which is disposed between the substrate and the pixel electrode.

Preferably, the LCD panel further comprises a second buffer layer for attenuating the energy of laser beam, which disposed between the substrate and the conductive layer.

Preferably, in the LCD panel, the conductive layer is made up of metal layer, the first buffer layer and the second buffer layer are made up of metal or semiconductor material, and the pixel electrode is made up of transparent metal oxide.

Preferably, the LCD panel further comprises an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the substrate and the first insulating layer, and the second buffer layer is disposed between the first insulating layer and the conductive layer.

Preferably, the LCD panel further comprises an insulating area for isolating each of the pixel electrode, the gate line and the data line from others, the insulating area includes a first insulating layer and a second insulating layer, the conductive layer is disposed between the first insulating layer and the second insulating layer, and the first and second buffer layer are disposed between the first insulating layer and the conductive layer.

Preferably, the LCD panel further comprises an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the conductive layer and the second insulating layer, and the second buffer layer is disposed between the first insulating layer and the conductive layer.

Another object of the present invention is to provide a LCD comprising the LCD panel as described above which can effectively prevent pixel electrodes from being damaged in the process of repairing dot defect.

Another object of the present invention is to provide a portable electronic apparatus comprising the LCD panel as described above which can effectively prevent pixel electrodes from being damaged in the process of repairing dot defect.

Another object of the present invention is to provide a method for repairing pixels having bright dot defect in the LCD panel as describe above, wherein a portion of the substrate corresponding to a pixel unit having a bright dot defect is irradiated using laser beam, so that the pixel electrode can be electrically connected to the gate line and/or the data line together after the conductive layer is melted.

Another object of the present invention is to provide a method for manufacturing a LCD panel, the LCD panel comprises: a substrate, data lines and gate lines formed on the substrate and intersecting each other, pixel electrodes disposed near the intersecting areas formed by the data lines and the gate lines, wherein, the method further comprising: forming a conductive layer having a part overlapped spatially with the pixel electrodes and another part overlapped spatially with the gate lines or the data lines, and forming a first buffer layer between the substrate and the pixel electrodes so as to attenuate the energy of laser beam.

Preferably, in the above method, a second buffer layer is formed between the substrate and the conductive layer so as to attenuate the energy of laser beam.

According to the present invention, when the bright dot defects in the LCD panel are repairing using laser-repairing, a portion of energy from the laser beam can be effectively absorbed by the first and second buffer layers, thereby the heating temperature due to the laser beam decreases, so as to prevent the pixel electrodes and conductive layer from being damaged caused by the too high temperature.

### BRIEF DESCRIPTION OF THE DRAWINGS

The above and other features and advantages of the present invention will become more apparent to those of ordinary skill in the art by describing in detail exemplary embodiments thereof with reference to the accompanying drawings, in which:

FIG. 1 illustrates an exploded view of a pixel unit of a LCD panel in the prior art, in which bright dot defects are repairable;

FIG. 2 illustrates a cross-sectional view taken along the VII-VII line shown in FIG. 1;

FIG. 3 illustrates a plan view of a pixel matrix substrate in a typical LCD panel;

FIG. 4 illustrates an enlarged schematic view of a pixel unit of LCD panel according to one of preferred embodiments of the present invention; and

FIG. 5 illustrates a cross-sectional view of a laser-repairing circuit in the pixel unit shown in FIG. 4, which is taken along the A-A′ line shown in FIG. 4.

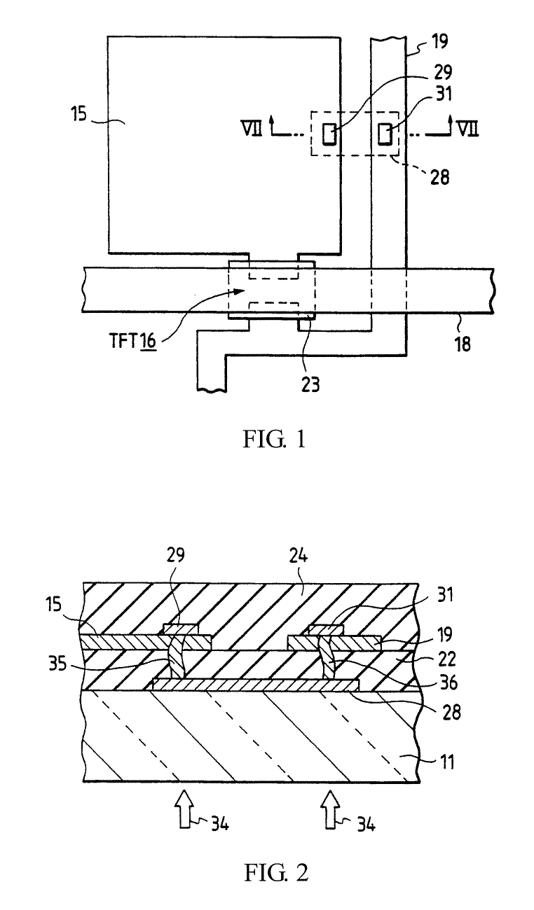

### DETAILED DESCRIPTION OF EMBODIMENTS OF THE INVENTION

Some exemplary embodiments of the present invention will now be described more fully hereinafter with reference to the accompanying drawings used to illustrate the present invention in detail. It will be noted by those of ordinary skill in the art that the present invention can be applied by means of various way, and not limited to some exemplary embodiments as set forth here. In addition, in the present invention, when a layer is referred to as being disposed or inserted between two layers, it shall be understood broadly that the layer can not only interface with the two layers but also be separated from the two layers by other layers.

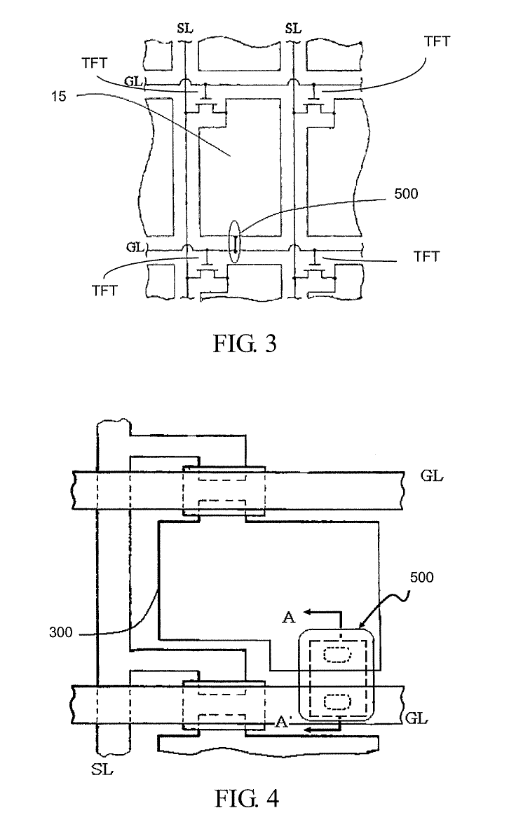

FIG. 3 illustrates a plan view of a pixel matrix substrate in a typical LCD panel. The pixel matrix of the LCD panel is formed on the substrate (not shown), and as shown in FIG. 3, includes a large number of gate lines GL and data lines SL intersecting each other, pixel electrode 15 disposed near the intersecting areas formed by the gate lines and the data lines, and thin film transistors (TFT) for connecting the pixel electrode 15 to the gate line and the data line; wherein a gate electrode and a source electrode of each TFT is connected to the gate line GL and the data line SL, respectively, and a drain electrode of each TFT is connected to the pixel electrode 15. In the above structure of the LCD panel, each TFT acts as a switch element for controlling the extent of brightness and darkness of a pixel unit.

When a bright dot defect occurs in a pixel unit, in order to make it become as a dark dot, as shown in FIG. 3, a laser-repairing circuit 500 can be disposed between the gate line GL, and pixel electrode 15 so as to electrically connect the pixel electrode 15 to the gate line GL under the irradiation of the laser beam.

FIG. 4 illustrates an enlarged schematic view of a pixel unit of LCD panel according to one of preferred embodiments of the present invention. As shown in FIG. 4, a laser-repairing circuit 500 is disposed between the pixel electrode 15 and the gate line GL. However, it shall be noted that the laser-repairing circuit 500 can also be disposed between the data line SL and the pixel electrode 15, or it can be disposed between the pixel electrode 15 and the gate line GL, and between the pixel electrode 15 and data line SL.

However, in this preferred embodiment of the present invention, the laser-repairing circuit 500 is disposed between the gate line GL and the pixel electrode 15; otherwise, the repaired pixel will flicker due to the unstable voltage of the data line.

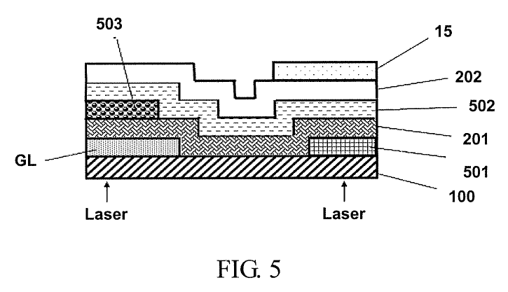

FIG. 5 illustrates a cross-sectional view of a laser-repairing circuit in the pixel unit shown in FIG. 4, which is taken along the A-A′ line shown in FIG. 4. As shown in FIG. 5, a gate line GL, is formed on a substrate 100, a gate line GL is isolated from a pixel electrode 15 by a first insulating layer 201 and a second insulating layer 202, a laser-repairing circuit 500 includes a first buffer layer 501 formed between the substrate 100 and the first insulating layer 201, a conductive layer 502 formed between the first insulating layer 201 and the second insulating layer 202, and a second buffer layer 503 formed between the first insulating layer 201 and the conductive layer 502. In this embodiment, the conductive layer 502 can be made up of metal layer, and the first buffer layer 501 and the second buffer layer 503 can be made up of metal or semiconductor material.

It shall be noted that the first buffer layer is used for absorbing a part of heat energy of the laser beam, thus it may be disposed in the path along which the laser beam travels. So does the second buffer layer, i.e., it may also be disposed in the path along which the laser beam travels.

The operational principle of the laser-repairing circuit will be described with reference to the accompanying drawings. Referring to FIG. 5, when the laser beam irradiates the substrate 100 in a vertical direction (as indicated by arrow in FIG. 5), the first insulating layer 201 and the second buffer layer 503 are punctured by the laser beam on the left side, the overlapped area of the conductive layer 502 and the gate line GL is melted by heat, thus the conductive layer 502 is connected electrically to the gate line GL; the first buffer layer 501, the first insulating layer 201, the conductive layer 502 and the second insulating layer 202 are punctured by the laser beam on right side, the area of the conductive layer 502 overlapping with the pixel electrode 15 is melted by heat, so that the conductive layer 502 is connected electrically to the pixel electrode 15. As a whole, the gate line GL, can be connected electrically to the pixel electrode 15 by the conductive layer 502, and a short circuit may thus be formed. Since there is a potential difference between the gate line GL and a common electrode (not shown) during the operation of the LCD panel, a potential difference between the corresponding pixel electrode 15 and common electrode would occur after the short circuit was formed between the gate line GL and the pixel electrode 15. In this way, a pixel unit having a bright dot defect may be repaired as one having a dark dot defect.

In this embodiment, the energy from the laser beam irradiated to the pixel electrode 15 can be absorbed partially because of the first buffer layer 501; thereby the pixel electrode 15 can be effectively prevented from being damaged by overheating from the laser beam. On the other hand, the energy from the laser beam irradiated to the conductive layer 502 can also be absorbed because of the second buffer layer 503, thereby the situation in which the resistance increases due to the break down of the conductive layer 502 by the laser beam will not occur.

It shall be noted that in order to prevent the pixel electrode 15 from being overheated, the first buffer layer 501 can be disposed between the substrate 100 and the pixel electrode 15, for example, the first buffer layer 501 can be disposed between the first insulating layer 201 and the conductive layer 502, or between the second insulating layer 202 and the conductive layer 502, or between the second insulating layer 202 and the pixel electrode 15. Preferably, the first and second buffer layers can be disposed between the substrate 100 and the conductive layer 502, for example, the second buffer layer 503 can be disposed between the first insulating layer 201 and the gate line GL, or between the substrate 100 and the gate line GL, so as to prevent the conductive layer 502 from being damaged due to overheating.

The process for forming the pixel matrix of the above LCD panel will be described with reference to the accompanying drawings. Referring to FIGS. 3 and 5, firstly, on the substrate 100, a metal film is deposited, patterned and etched so as to form the gate line GL and the first buffer layer 501; then, an insulating film is deposited on the gate line GL and the first buffer layer 501 to form the first insulating layer 201; then, on the first insulating layer 201, a semiconductor layer is formed, patterned and etched so as to form a semiconductor layer in TFT (not shown) and the second buffer layer 503; then, on the second buffer layer 503 and the first insulating layer 201, a metal film is deposited, patterned and etched so as to form the data line and conductive layer 502; then, an insulating film is deposited on the data line and the conductive layer 502 so as to form the second insulating layer 202; finally, a layer made of metal oxide material is deposited on the second insulating layer 202 so as to form the pixel electrode 15.

The LCD panel according to the present invention have been described herein by means of the above preferred embodiments. Apparently, the above LCD panel may be applied to a variety of LCDs and portable electronic apparatuses. The said portable electronic apparatuses include but do not limit to notebook computer, mobile telephone, MP4 player and Personal Digital Assistant (PDA) and the like.

The above particular description of the present invention by means of some exemplary embodiments is only used to explain its technique content, and not for purpose of limitation. Accordingly, it will be understood by those of ordinary skill in the art that various changes in form and details may be made without departing from the spirit and scope of the present invention as set forth in the following claims.

What is claimed is:

1. A liquid crystal display (LCD) panel, comprising: a substrate and a plurality of pixel units formed on the substrate, each of the pixel units comprising a data line, a gate line intersecting the data line and a pixel electrode disposed near intersecting area formed by the data line and the gate line, wherein, each of the pixel units further comprising:
a conductive layer having a part overlapped spatially with the pixel electrode and another part overlapped spatially with the gate line or the data line; and,
a first buffer layer for attenuating the energy of laser beam, which is disposed between the substrate and the pixel electrode.

2. The LCD panel as claimed in claim 1, further comprising a second buffer layer for attenuating the energy of laser beam, which disposed between the substrate and the conductive layer.

3. The LCD panel as claimed in claim 2, wherein the conductive layer is made up of metal layer, the first buffer layer and the second buffer layer are made up of metal or semiconductor material, and the pixel electrode is made up of transparent metal oxide.

4. The LCD panel as claimed in claim 2, further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the substrate and the first insulating layer, and the second buffer layer is disposed between the first insulating layer and the conductive layer.

5. The LCD panel as claimed in claim 2, further comprising an insulating area for isolating each of the pixel electrode, the gate line and the data line from others, the insulating area includes a first insulating layer and a second insulating layer, the conductive layer is disposed between the first insulating layer and the second insulating layer, and the first and second buffer layer are disposed between the first insulating layer and the conductive layer.

6. The LCD panel as claimed in claim 2, further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the conductive layer and the second insulating layer, and the second buffer layer is disposed between the first insulating layer and the conductive layer.

7. A liquid crystal display (LCD) including a LCD panel, wherein, the LCD panel comprising: a substrate and a plurality of pixel units formed on the substrate, each of the pixel units comprising a data line, a gate line intersecting the data line and a pixel electrode disposed near intersecting area formed by the data line and the gate line, wherein, each of the pixel units further comprising:
a conductive layer having a part overlapped spatially with the pixel electrode and another part overlapped spatially with the gate line or the data line; and,
a first buffer layer for attenuating the energy of laser beam, which is disposed between the substrate and the pixel electrode.

8. The liquid crystal display (LCD) as claimed in claim 7, wherein the LCD panel further comprising a second buffer layer for attenuating the energy of laser beam, which disposed between the substrate and the conductive layer.

9. The liquid crystal display (LCD) as claimed in claim 7, wherein the conductive layer is made up of metal layer, the first buffer layer and the second buffer layer are made up of metal or semiconductor material, and the pixel electrode is made up of transparent metal oxide.

10. The liquid crystal display (LCD) as claimed in claim 7, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the substrate and the first insulating layer, and the second buffer layer is disposed between the first insulating layer and the conductive layer.

11. The liquid crystal display (LCD) as claimed in claim 7, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, and the first and second buffer layer are disposed between the first insulating layer and the conductive layer.

12. The liquid crystal display (LCD) as claimed in claim 7, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the conductive layer and the second insulating layer, and the second buffer layer is disposed between the first insulating layer and the conductive layer.

13. A portable electronic apparatus including a LCD panel, wherein the LCD panel comprising: a substrate and a plurality of pixel units formed on the substrate, each of the pixel units comprising a data line, a gate line intersecting the data line and a pixel electrode disposed near intersecting area formed by the data line and the gate line, wherein, each of the pixel units further comprising:
a conductive layer having a part overlapped spatially with the pixel electrode and another part overlapped spatially with the gate line or the data line; and,
a first buffer layer for attenuating the energy of laser beam, which is disposed between the substrate and the pixel electrode.

14. The portable electronic apparatus as claimed in claim 13, wherein the LCD panel further comprising a second buffer layer for attenuating the energy of laser beam, which disposed between the substrate and the conductive layer.

15. The portable electronic apparatus as claimed in claim 13, wherein the conductive layer is made up of metal layer, the first buffer layer and the second buffer layer are made up of metal or semiconductor material, and the pixel electrode is made up of transparent metal oxide.

16. The portable electronic apparatus as claimed in claim 13, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the substrate and the first insulating layer, and the second buffer layer is disposed between the first insulating layer and the conductive layer.

17. The portable electronic apparatus as claimed in claim 13, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, and the first and second buffer layer are disposed between the first insulating layer and the conductive layer.

18. The portable electronic apparatus as claimed in claim 13, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the conductive layer and the second insulating layer, and the second buffer layer is disposed between the first insulating layer and the conductive layer.

19. The portable electronic apparatus as claimed in claim 13, wherein the portable electronic apparatus is one of notebook computer, mobile telephone, MP4 player and Personal Digital Assistant (PDA).

20. The portable electronic apparatus as claimed in claim 14, wherein the portable electronic apparatus is one of notebook computer, mobile telephone, MP4 player and Personal Digital Assistant (PDA).

21. The portable electronic apparatus as claimed in claim 15, wherein the portable electronic apparatus is one of notebook computer, mobile telephone, MP4 player and Personal Digital Assistant (PDA).

22. The portable electronic apparatus as claimed in claim 16, wherein the portable electronic apparatus is one of notebook computer, mobile telephone, MP4 player and Personal Digital Assistant (PDA).

23. The portable electronic apparatus as claimed in claim 17, wherein the portable electronic apparatus is one of notebook computer, mobile telephone, MP4 player and Personal Digital Assistant (PDA).

24. The portable electronic apparatus as claimed in claim 18, wherein the portable electronic apparatus is one of notebook computer, mobile telephone, MP4 player and Personal Digital Assistant (PDA).

25. A method for repairing pixels having bright dot defect in a LCD panel, the LCD panel comprising: a substrate and a plurality of pixel units formed on the substrate, each of the pixel units comprising a data line, a gate line intersecting the data line and a pixel electrode disposed near intersecting area formed by the data line and the gate line, wherein, each of the pixel units further comprising:
a conductive layer having a part overlapped spatially with the pixel electrode and another part overlapped spatially with the gate line or the data line; and,
a first buffer layer for attenuating the energy of laser beam, which is disposed between the substrate and the pixel electrode,
wherein a portion of the substrate corresponding to a pixel unit having a bright dot defect is irradiated using laser beam, so that the pixel electrode can be electrically connected to the gate line and/or the data line together after the conductive layer is melted.

26. The method as claimed in claim 25, wherein the LCD panel further comprising a second buffer layer for attenuating the energy of laser beam, which disposed between the substrate and the conductive layer.

27. The method as claimed in claim 25, wherein the conductive layer is made up of metal layer, the first buffer layer and the second buffer layer are made up of metal or semiconductor material, and the pixel electrode is made up of transparent metal oxide.

28. The method as claimed in claim 25, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the substrate and the first insulating layer, and the second buffer layer is disposed between the first insulating layer and the conductive layer.

29. The method as claimed in claim 25, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, and the first and second buffer layer are disposed between the first insulating layer and the conductive layer.

30. The method as claimed in claim 25, wherein the LCD panel further comprising an insulating area for isolating each of the pixel electrode, the gate line and the data line from others, the insulating area includes a first insulating layer and a second insulating layer, the conductive layer is disposed between the first insulating layer and the second insulating layer, the first buffer layer is disposed between the conductive layer and the second insulating layer, and the second buffer layer is disposed between the first insulating layer and the conductive layer.

31. A method for manufacturing a LCD panel, wherein the LCD panel comprises: a substrate, data lines and gate lines formed on the substrate and intersecting each other, pixel electrodes disposed near intersecting areas formed by the data lines and the gate lines, wherein, the method further comprising: forming a conductive layer having a part overlapped spatially with the pixel electrodes and another part overlapped spatially with the gate lines or the data lines, and forming a first buffer layer between the substrate and the pixel electrodes so as to attenuate the energy of laser beam.

32. The method as claimed in claim 31, wherein a second buffer layer is formed between the substrate and the conductive layer so as to attenuate the energy of laser beam.
